(19) United States
(12) Patent Application Publication
(10) Pub. No.: US 2013/0306700 A1
(43) Pub. Date: Nov. 21, 2013

(54) STAPLER WITH LEG-FLATTENING AND ANVIL-LIMITING CAPABILITY

(71) Applicant: Chien-Hsing CHANG, Chang Hua (TW)

(72) Inventor: Chien-Hsing CHANG, Chang Hua (TW)

(21) Appl. No.: 13/473,722

(22) Filed: May 17, 2012

(51) Int. Cl. B25C 5/02

(52) U.S. Cl. 227/120

(57) ABSTRACT

A stapler has a supporting base, a magazine assembly, a trigger assembly and a leg-flattening device. The supporting base has multiple limiting blocks to define a receiving segment by and between the limiting blocks. The leg-flattening device is mounted on the supporting base and has an anvil element and a moving base. The anvil element has two guiding legs mounted in the receiving segment in the supporting base. The clinching segment is formed on the top of the anvil element. The moving base is connected pivotally to the supporting base and has an anvil hole and two limiting arms. The anvil element is exposed from the moving base via the anvil hole. The limiting arms are formed respectively on and protrude downward from two sides of the moving base and are close respectively to the guiding legs of the anvil element.

### BACKGROUND OF THE INVENTION

1. Field of the Invention

The present invention relates to a stapler, and more particularly to a stapler having an anvil-limiting device to provide a limiting effect to the movement of an anvil and to improve the leg-flattening effect of the stapler.

2. Description of Related Art

To improve a stapling effect, a conventional stapler has a leg-flattening device to force flat legs of a staple flat, such that a person and document can be prevented from being injured or broken by the legs of the staple. The leg-flattening device has a fixed anvil element to flatten the legs of the staple, and the anvil element of the conventional stapler is secured on a supporting base of the conventional stapler. However, there is a gap between the conventional fixed anvil element and the staple, and the gap easily causes low quality of leg-flattening effect.

Another type of conventional leg-flattening device has a slidable anvil element to solve the problem caused by the fixed anvil element. However, the conventional stapler cannot provide a supporting effect to the slidable anvil element, the slidable anvil element is easily inclined so the leg-flattening effect is also poor.

With reference to FIG. 9, a conventional stapler 60 has a supporting base 61 and a slidable anvil element 62. The supporting base 61 has two guiding channels 611 defined respectively in opposite side faces of the supporting base 61. The anvil element 62 is mounted moveably in the supporting base 61 and has a top and two sides. The top is used to clinch legs of a staple and serves as a functional segment. The sides are mounted respectively in the guiding channels 611 and serve as a non-functional segment. With the guiding channels 611, a guiding effect is provided to the anvil element 62 to enable the anvil element 62 to slide stably during a leg-flattening process of the stapler. A spring 612 is mounted between the supporting base 61 and the anvil element 62 and provides a recoil force and pushes the anvil element 62 to move upwardly.

However, the non-functional segment of the anvil element 62 is not completely mounted in, but partially exposed from, the guiding channels 611. The movement of the anvil element 62 is easily influenced due to external factors. For example, the anvil element 62 may be blocked by an object at a position between the non-functional segment and a corresponding side face of the supporting base 61 to cause unstable movement of the anvil element 62. In addition, the anvil element 62 must have a sufficient width to make the sides of the anvil element 62 be held in the guiding channels 611, or the supporting base 61 must have a sufficient width to fit with that of the anvil element 62. Therefore, the sizes of the other elements of the stapler are limited accordingly, so the design range for a stapler is also limited.

To overcome the shortcomings, the present invention tends to provide a stapler to mitigate or obviate the aforementioned problems.

### SUMMARY OF THE INVENTION

The main objective of the invention is to provide a stapler having a leg-flattening capability to make an anvil move stably.

The stapler has a supporting base, a magazine assembly, a trigger assembly and a leg-flattening device. The supporting base has a bottom face, two side faces, multiple limiting blocks and a receiving segment. The limiting blocks are formed on and protrude from the bottom face of the supporting base and are spaced from the side faces of the supporting base. The receiving segment is defined by and between the limiting blocks. The magazine assembly is connected pivotally to the supporting base. The trigger assembly is connected pivotally to the supporting base and above the magazine assembly. The leg-flattening device is mounted on the supporting base and has an anvil element and a moving base. The anvil element has a top, two sides, two guiding legs and a clinching segment. The guiding legs are respectively formed on and protrude downward from the sides of the anvil element and are mounted in the receiving segment in the supporting base. The clinching segment is formed on the top of the anvil element. The moving base is connected pivotally to the supporting base and has a rear end, a front end, an anvil hole and two limiting arms. The rear end is pivotally connected to the supporting base. The front end is opposite to the rear end. The anvil hole is defined through the front end of the moving base, and the clinching segment of the anvil element is exposed from the moving base via the anvil hole. The limiting arms are formed respectively on and protrude downward from two sides of the moving base and are close respectively to the guiding legs of the anvil element.

With such an arrangement, the stapler in accordance with the present invention has the following advantages and improvements.

1. With the arrangement of the limiting blocks on the supporting base and the limiting arms on the moving base, the movement of the guiding legs of the anvil element can be limited to keep the guiding legs of the anvil element close to the limiting blocks and the limiting arms before or during the operation of the anvil element. Thus, the anvil element can only be limited to move upward and downward and the vacillation of the anvil element can be efficiently prevented. When the stapler is in use, the anvil element will move upward and downward in the receiving segment in the supporting base. The clinching groove in the anvil element can hold and support the released staple from the magazine assembly and guide the released staple to a desired position. Accordingly, the leg-flattening effect of the stapler can be improved.

2. Because the guiding legs of the anvil element are enclosed beneath the moving base and within the space formed between the limiting arms on the moving base, only the clinching segment is exposed from the anvil hole in the moving base. Therefore, the movement of the anvil element will not be influenced or blocked by external factors, and the movement of the anvil element is smooth. With the limitation to the movement of the anvil element, the leg-flattening effect of the stapler can be efficiently improved.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a stapler in accordance with the present invention;

FIG. 2 is a partially exploded perspective view of the stapler in FIG. 1;

FIG. 3 is another partially exploded perspective view of the stapler in FIG. 1;

FIG. 4 is an enlarged partial perspective view of the stapler in FIG. 1;

FIG. 5 is an enlarged cross sectional top view of the stapler in FIG. 4;

FIG. 6 is an enlarged cross sectional front view of the stapler in FIG. 4;

FIG. 6A is an enlarged front view of the anvil element of the stapler in FIG. 6;

FIG. 7 is an operational front view in partial section of the stapler in FIG. 1 showing a leg-flattening process;

FIG. 8 is a front view in partial section of another embodiment of a stapler in accordance with the present invention; and

FIG. 9 is a partially exploded perspective view of a conventional stapler in accordance with the prior art.

### DETAILED DESCRIPTION OF PREFERRED EMBODIMENT

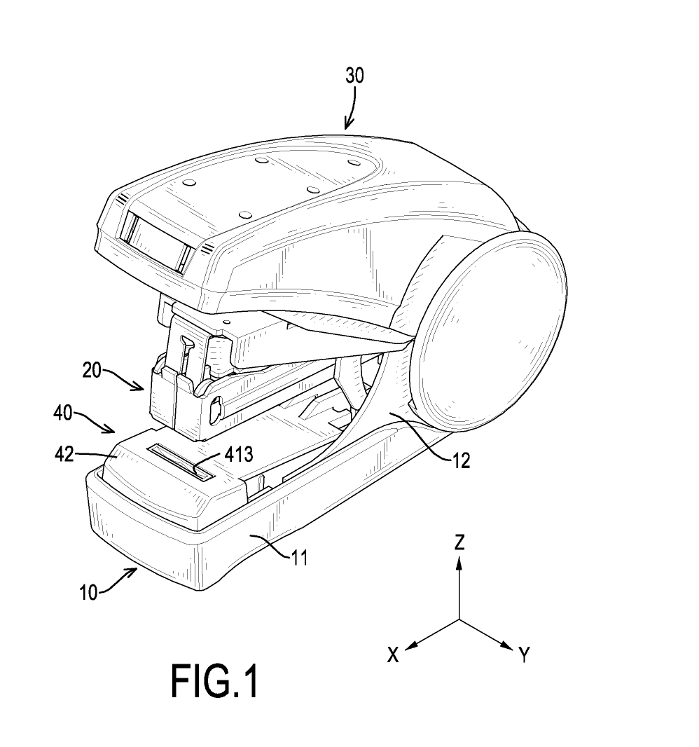

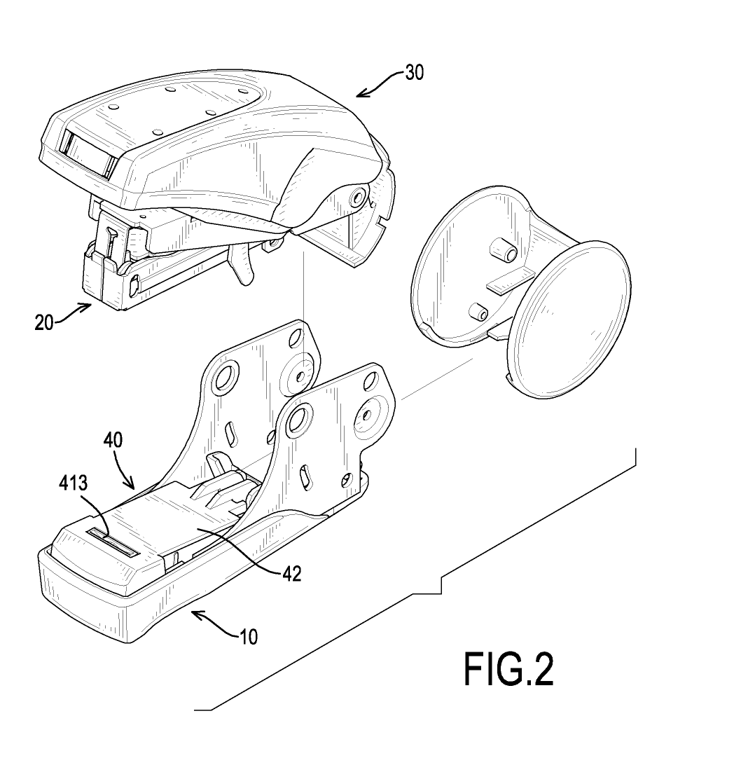

With reference to FIGS. 1 to 3, a stapler in accordance with the present invention comprises a supporting base 10, a magazine assembly 20, a trigger assembly 30 and a leg-flattening device 40. The magazine assembly 20 is connected pivotally to the supporting base 10 and holds staples inside. The trigger assembly 30 is connected pivotally to the supporting base 10 and is above the magazine assembly 20. The magazine assembly 20 and the trigger assembly 30 may be conventional, so the detail structures of the magazine assembly 20 and the trigger assembly 30 are omitted.

With reference to FIG. 5, the supporting base 10 has a bottom face and two side faces and may comprise a lower base 11 and an upper base 12. The lower base 11 may be plastic and has a U-shaped cross section to form a bottom and two sidewalls. The bottom and the sidewalls of the lower base 11 can serve respectively as the bottom face and the side faces of the supporting base 10. The lower base 11 has multiple limiting blocks 13 formed on and protruding from the bottom near one end of the lower base 11 and spaced from the sidewalls of the lower base 11. A receiving segment 14 is defined by and between the limiting blocks 13. Preferably, four limiting blocks are formed on and protrude from the bottom of the lower base 11 and are arranged in two pairs each having two limiting blocks 13 facing to each other. The receiving segment 14 is formed between the four limiting blocks. The upper base 12 may be metal, is combined with the lower base 11 and has a U-shaped cross section.

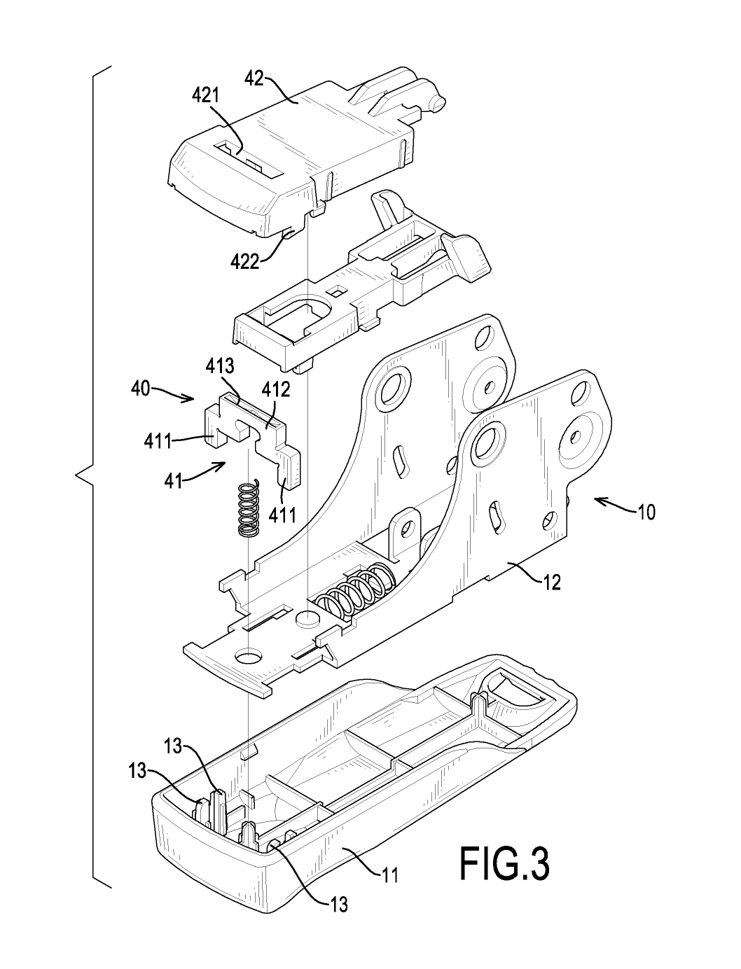

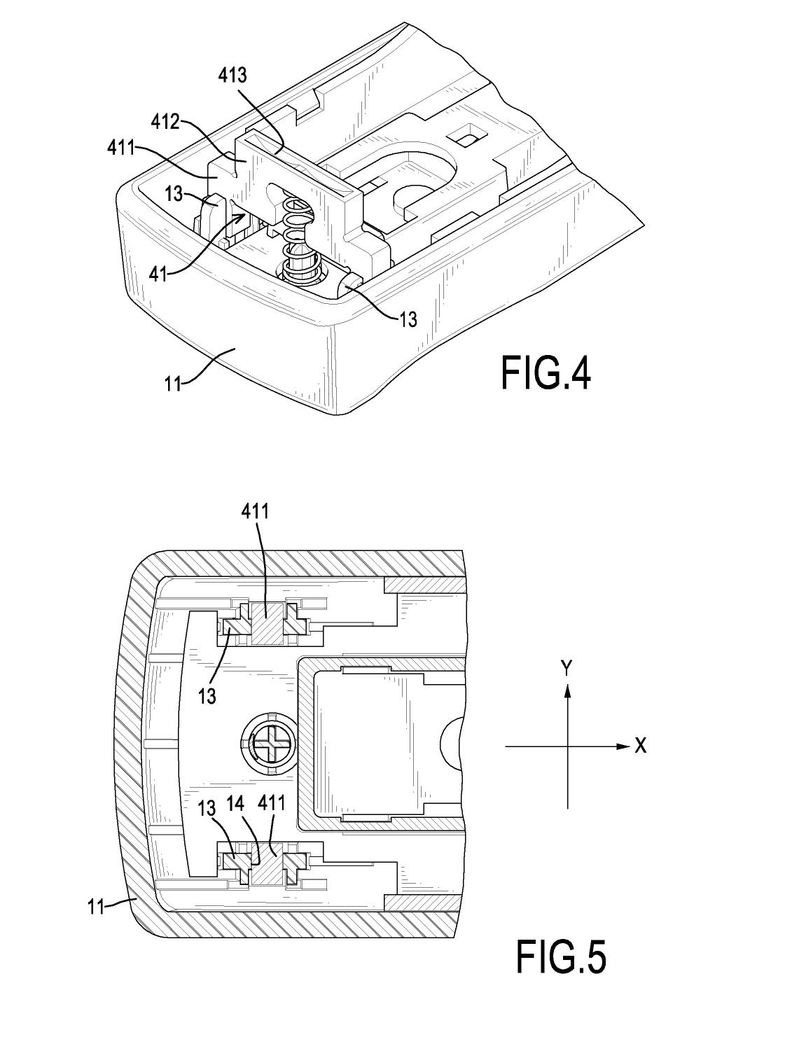

With reference to FIGS. 3 to 6, the leg-flattening device 40 is mounted on the supporting base 10 and has an anvil element 41 and a moving base 42. The anvil element 41 is a metal sheet and has a top, two sides, two guiding legs 411 and a clinching segment 412. The guiding legs 411 are respectively formed on and protrude downward from the sides of the anvil element 41. The guiding legs 411 are slidably mounted in the receiving segment 14 in the lower base 11, and each guiding leg 411 is mounted between two of the limiting blocks 13. Accordingly, the anvil element 41 is kept from moving relative to the supporting base 10 along the X-axis as shown in FIG. 5. The clinching segment 412 is formed on the top of the anvil element 41 and has a clinching groove 413 formed in the top of the clinching segment 412.

The moving base 42 has a front end, a rear end and an anvil hole 421. The rear end of the moving base 42 is connected pivotally with the upper base 12, such that the moving base 42 will be pivoted downward relative to the supporting base 10 when the trigger assembly 30 is pressed to pivot the magazine assembly 20 downward to release the staples mounted in the magazine assembly 20. Two legs of the released staple are abut the bottom of the clinching groove 413 in the anvil element 41. The anvil hole 421 is formed through the front end of the moving base 42 opposite to the rear end that is connected pivotally with the upper base 12. The clinching segment 412 of the anvil element 41 is exposed from the top of the moving base 42 via the anvil hole 421, and the guiding legs 411 of the anvil element 41 is enclosed within and below the moving base 42. Accordingly, the clinching segment 412 is the only exposed part of the anvil element 41 that is exposed from the moving base 42 via the anvil hole 421. The moving base 42 further has two limiting arms 422 formed respectively on and protruding downward from two sides of the moving base 42. The limiting arms 422 are respectively close to the guiding legs 411 of the anvil element 41, such that the movement of the anvil element 41 relative to the supporting base 10 and the moving base 42 along the Y-axis as shown in FIG. 5 is prevented.

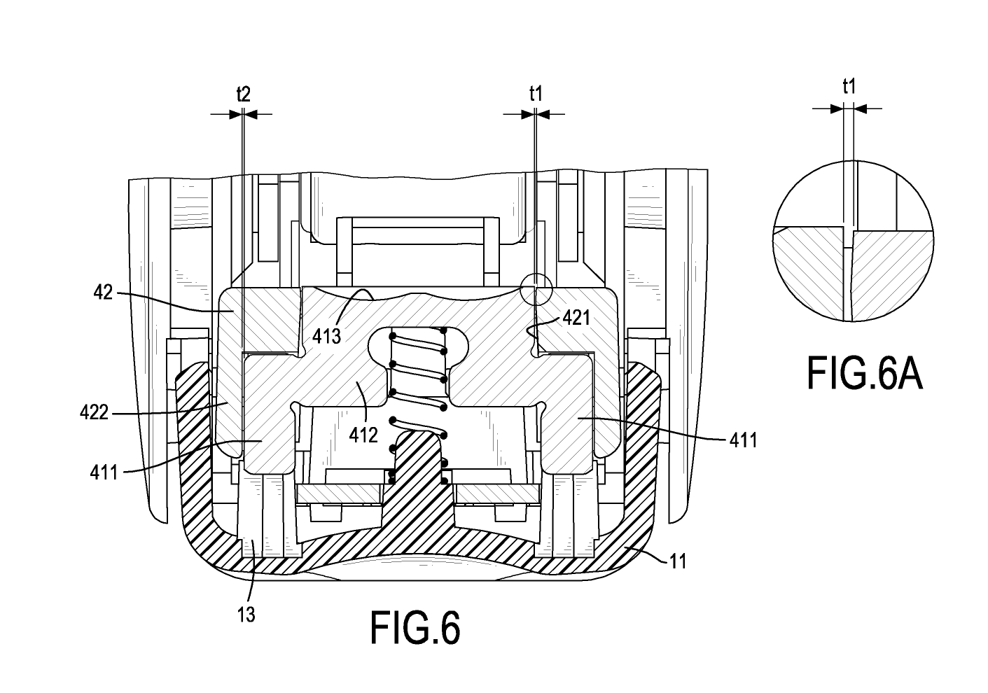

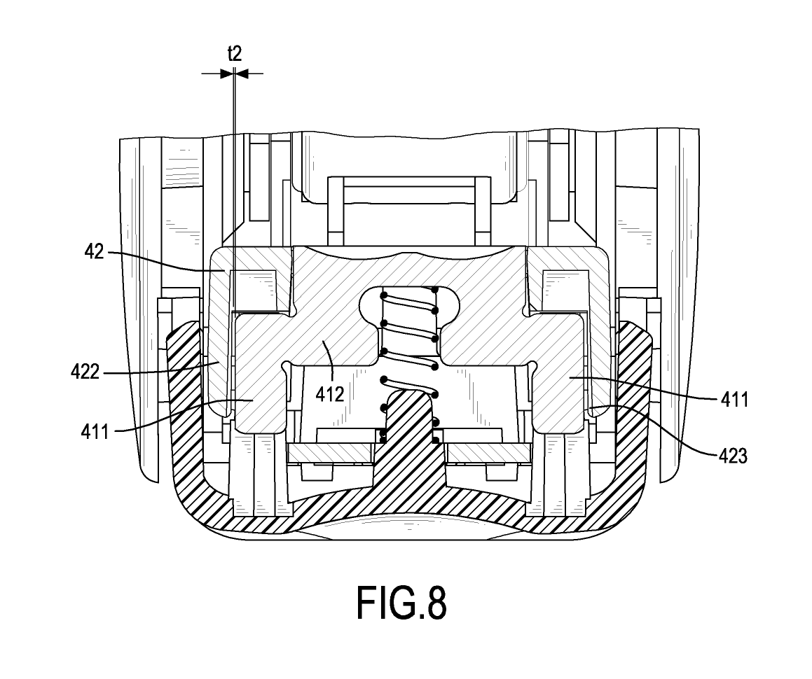

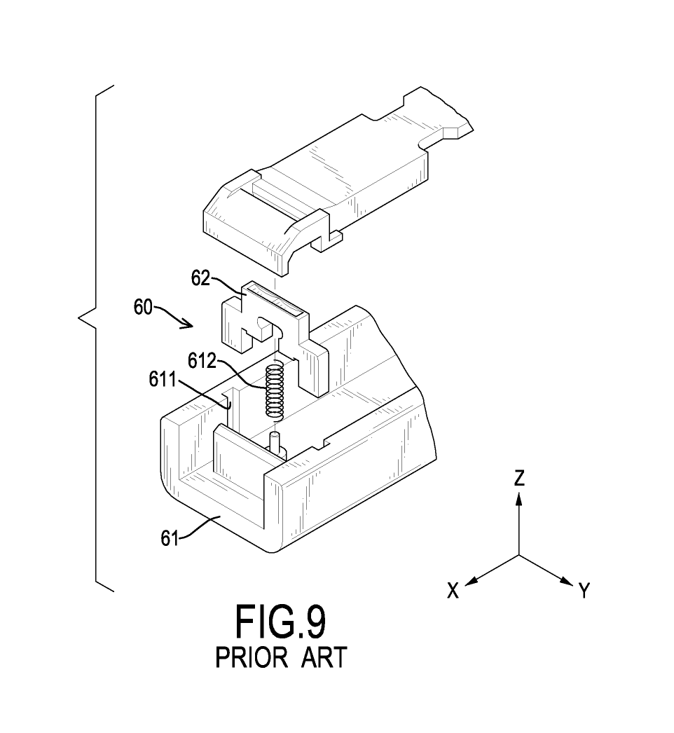

With reference to FIGS. 6 and 6A, a first gap t₁ is formed between each side of the clinching segment 412 of the anvil element 41 and a corresponding inner side wall of the anvil hole 421 in the moving base 42. The first gap t₁ has a width larger than 0 millimeter (mm) and smaller than or equal to 0.2 mm, i.e. 0<t₁≦0.2 mm. A second gap t₂ is formed between each guiding leg 411 of the anvil element 41 and a corresponding limiting arm 422 on the moving base 42, and the second gap t₂ has a width larger than 0 millimeter (mm) and smaller than or equal to 1.7 mm, i.e. 0<t₂≦1.7 mm. Preferably, the width of the second gap t₂ is larger than 0 millimeter (mm) and smaller than or equal to 0.5 mm, i.e. 0<t₂≦0.5 mm. The width of the second gap t₂ between each limiting arm 422 of the moving base 42 and the corresponding guiding leg 411 is variable by increasing or decreasing the thickness of the limiting arm 422 so as to adjust the distance between the limiting arm 422 and the corresponding guiding leg 411 of the anvil element 41. Alternatively, with reference to FIG. 8, each limiting arm 422 has a rib 423 formed on and protruding from the limiting arm 422 to approach the corresponding guiding leg 411, such that the width of the second gap t₂ can be changed and the movement of the anvil element 41 can be limited.

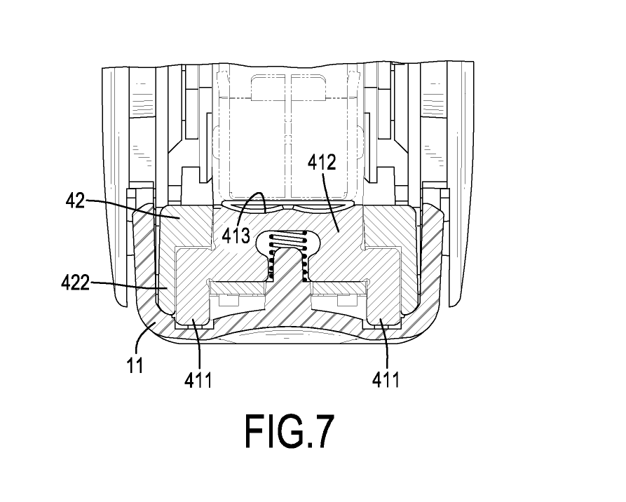

With reference to FIGS. 6 and 7, with the arrangement of the limiting blocks 13 on the supporting base 10 and the limiting arms 422 on the moving base 42, the movement of the guiding legs 411 of the anvil element 41 along the X- and Y-axes can be limited. The guiding legs 411 of the anvil element 41 are close to the limiting blocks 13 on the supporting base 10 and the limiting arms 422 on the moving base 42, such that the anvil element 41 can be limited to move only along the Z-axis. Accordingly, the movement of the anvil element 41 is stable and the vacillation of the anvil element 41 can be completely prevented. When the stapler is in use, the anvil element 41 will move upward and downward in the receiving segment 14 in the supporting base 10 along the Z-axis. The clinching groove 413 in the anvil element 41 can hold and support the released staple from the magazine assembly 20 and guide the released staple to a desired position. Thus, the leg-flattening effect of the stapler can be improved.

Furthermore, because the guiding legs 411 of the anvil element 41 are enclosed within the space formed between the limiting arms 422 on the moving base 42, only the clinching segment 412 is exposed from the anvil hole 421 in the moving base 42. An object is kept from a position between the guiding legs 411 of the anvil element 41 and the side faces of the supporting base 10, so the movement of the anvil element 41 will not be influenced or blocked by external factors. With the limitation to the movement of the anvil element 41, the leg-flattening effect of the stapler can be efficiently improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A stapler comprising:
a supporting base having:
a bottom face;
two side faces;
multiple limiting blocks formed on and protruding from the bottom face of the supporting base and spaced from the side faces of the supporting base; and
a receiving segment defined by and between the limiting blocks;
a magazine assembly connected pivotally to the supporting base;
a trigger assembly connected pivotally to the supporting base and above the magazine assembly; and
a leg-flattening device mounted on the supporting base and having
an anvil element having
a top;
two sides;
two guiding legs respectively formed on and protruding downward from the sides of the anvil element and mounted in the receiving segment in the supporting base; and
a clinching segment formed on the top of the anvil element; and
a moving base connected pivotally to the supporting base and having
a rear end pivotally connected to the supporting base;
a front end opposite to the rear end;
an anvil hole defined through the front end of the moving base, wherein the clinching segment of the anvil element is exposed from the moving base via the anvil hole; and
two limiting arms formed respectively on and protruding downward from two sides of the moving base and being close respectively to the guiding legs of the anvil element.

2. The stapler as claimed in claim 1, wherein each limiting arm of the moving base has a rib formed on and protruding from the limiting arm and being close to a corresponding one of the guiding legs of the anvil element.

3. The stapler as claimed in claim 2, wherein four limiting blocks are implemented to form the receiving segment between the four limiting blocks, are formed on the bottom face of the supporting base and are arranged in two pairs each having two limiting blocks facing to each other; and
each guiding leg of the anvil element is mounted between corresponding two of the limiting blocks.

4. The stapler as claimed in claim 3, wherein
the supporting base comprises
a lower base having a U-shaped cross section to form a bottom and two sides; and
an upper base mounted in the lower base and having a U-shaped cross section; and
the moving base is pivotally connected with the upper base.

5. The stapler as claimed in claim 4, wherein the bottom and the sides of the lower base serve respectively as the bottom face and the side faces of the supporting base.

6. The stapler as claimed in claim 5, wherein a first gap is formed between each side of the clinching segment of the anvil element and a corresponding inner side wall of the anvil hole in the moving base and has a width larger than 0 millimeter (mm) and smaller than or equal to 0.2 mm.

7. The stapler as claimed in claim 6, wherein a second gap is formed between each guiding leg of the anvil element and a corresponding limiting arm on the moving base and has a width larger than 0 millimeter (mm) and smaller than or equal to 1.7 mm.

8. The stapler as claimed in claim 7, wherein the width of each second gap is larger than 0 millimeter (mm) and smaller than or equal to 0.5 mm.

9. The stapler as claimed in claim 1, wherein four limiting blocks are implemented to form the receiving segment between the four limiting blocks, are formed on the bottom face of the supporting base and are arranged in two pairs each having two limiting blocks facing to each other; and
each guiding leg of the anvil element is mounted between corresponding two of the limiting blocks.

10. The stapler as claimed in claim 9, wherein
the supporting base comprises
a lower base having a U-shaped cross section to form a bottom and two sides; and
an upper base mounted in the lower base and having a U-shaped cross section; and
the moving base is pivotally connected with the upper base.

11. The stapler as claimed in claim 10, wherein the bottom and the sides of the lower base serve respectively as the bottom face and the side faces of the supporting base.

12. The stapler as claimed in claim 11, wherein a first gap is formed between each side of the clinching segment of the anvil element and a corresponding inner side wall of the anvil hole in the moving base and has a width larger than 0 millimeter (mm) and smaller than or equal to 0.2 mm.

13. The stapler as claimed in claim 12, wherein a second gap is formed between each guiding leg of the anvil element and a corresponding limiting arm on the moving base and has a width larger than 0 millimeter (mm) and smaller than or equal to 1.7 mm.

14. The stapler as claimed in claim 13, wherein the width of each second gap is larger than 0 millimeter (mm) and smaller than or equal to 0.5 mm.

15. The stapler as claimed in claim 1, wherein
the supporting base comprises
a lower base having a U-shaped cross section to form a bottom and two sides; and
an upper base mounted in the lower base and having a U-shaped cross section; and
the moving base is pivotally connected with the upper base.

16. The stapler as claimed in claim 15, wherein the bottom and the sides of the lower base serve respectively as the bottom face and the side faces of the supporting base.

17. The stapler as claimed in claim 1, wherein a first gap is formed between each side of the clinching segment of the anvil element and a corresponding inner side wall of the anvil hole in the moving base and has a width larger than 0 millimeter (mm) and smaller than or equal to 0.2 mm.

18. The stapler as claimed in claim 1, wherein a gap is formed between each guiding leg of the anvil element and a corresponding limiting arm on the moving base and has a width larger than 0 millimeter (mm) and smaller than or equal to 1.7 mm.

19. The stapler as claimed in claim 18, wherein the width of each gap is larger than 0 millimeter (mm) and smaller than or equal to 0.5 mm.
